(19) United States
(12) Patent Application Publication
(10) Pub. No.: US 2002/0195919 A1
(43) Pub. Date: Dec. 26, 2002

(54) Cathode for electron tube and method of preparing the cathode

(76) Inventors: Jong-Seo Choi, Anyang-city (KR); Dong-Hee Han, Suwon-city (KR); Seung-Kwon Han, Seoul (KR); Dong-Kyun Seo, Suwon-city (KR); Bu-Chul Sin, Seoul (KR); Hwan-Chul Rho, Pusan (KR)

Correspondence Address: Robert E. Bushnell, Suite 300, 1522 K Street, N.W., Washington, DC, 20005, US

(21) Appl. No.: 09/964,375

(22) Filed: Sep. 28, 2001

Related U.S. Application Data
(60) Provisional application No. 60/299,786, filed on Jun. 22, 2001.

(51) Int. Cl. H01J 1/14

(52) U.S. Cl. 313/346 R

(57) ABSTRACT

A cathode for an electron tube, including a metal base and an electron-emitting material layer coated on the metal base, where the electron-emitting material layer contains a needle-shaped conductive material and the surface roughness corresponding to a distance between the highest point and the lowest point on the surface of the electron-emitting material layer is controlled to be under 10 microns. A needle-shaped conductive material is contained in an electron-emitting material layer to effectively form a conductive path, thereby minimizing the generation of Joule heat due to self-heating of the electron-emitting material layer. Also, grain and pore sizes of the electron-emitting material layer are uniformly controlled and the density and porosity of the electron-emitting material layer are also controlled, thereby improving the density and surface planarity of the cathode compared to the conventional cathode manufactured by a spraying method. Thus, during the operation of the cathode, shrinkage of the cathode can be prevented and uniformity in the distance between a cathode and a first grid can be maintained, thereby improving a lifetime characteristic and exhibiting a stable emission characteristic. Therefore, the electron tube cathode can remarkably improve a lifetime characteristic even for a high current density, which is needed for a larger and higher-definition cathode-ray tube.

### CLAIM OF PRIORITY

This application makes reference to, incorporates the same herein, and claims all benefits accruing under 35 U.S.C. §119 from a provisional application entitled CATHODE FOR ELECTRON TUBE AND PREPARING METHOD THEREFOR earlier filed under 35 U.S.C. §111(b) with the United States Patent & Trademark Office on Jun. 22, 2001 and there duly assigned Ser. No. 60/299,786.

### BACKGROUND OF THE INVENTION

1. Field of the Invention

The present invention relates to a cathode for an electron tube and a method of preparing the cathode, and more particularly, to improvement of the lifetime characteristics of a thermal electron-emitting cathode coated with an oxide (also called an oxide cathode) that is widely employed in general CRTs (cathode-ray tubes).

2. Description of the Related Art

A cathode includes a disk-like metal base, a cylindrical sleeve which is fitted to the bottom surface of the metal base for support and provided with a heater located inside the same for heating the cathode, and an electron-emitting material layer coated on the upper surface of the metal base. The oxide cathode for an electron tube has the advantage of a relatively low operating temperature (700 to 800 degrees Celsius) due to the low work function, so that it is widely employed in general cathode-ray tubes.

Earlier oxide cathodes for electron tubes are generally configured such that the electron-emitting material layer made of a barium-based alkali-earth metal carbonate, preferably a ternary carbonate containing barium, strontium and calcium in the form of (Ba—Sr—Ca)CO₃ or a binary carbonate containing barium, strontium and calcium in the form of (Ba—Sr)CO₃, is coated over the it metal base made of a nickel-based compound containing traces of a reducing agent such as silicon (Si), magnesium (Mg) or tungsten (W). The carbonate is converted into oxide by an evacuation or activation process and functions as an electron-emitting material.

A general process of manufacturing an oxide cathode and electron emission principles will now be described.

Carbonate powder with barium carbonate as a main component is mixed with an organic solvent in which a binder such as nitrocellulose is dissolved. A metal base is coated with the mixture by spraying or electrodeposition, and mounted on an electron gun for an electron tube. In the evacuation step of an electron tube, the carbonate is heated up to 1,000 degrees Celsius by a heater and changed into barium oxide as expressed by formula (1):

BaCO₃→BaO+CO₂↑ (1)

During the operation of the cathode, barium oxide reacts with the reducing agent in the metal base, such as Mg or Si, at the oxide/metal interface according to the following reactions to produce free barium, which is the source of the electron emission:

BaO+Mg→MgO+Bat↑ (2)

4BaO+Si→Ba₂SiO₄+2Ba↑ (3)

As free barium plays the role of an electron donor, the cathode oxide physically becomes an n-type semiconductor during the operation of the cathode. In general, when a large amount of current flows in a semiconductor, Joule heat is generated due to its own resistance. If the generation of Joule heat lasts for a long period, raw material evaporates or melts by self-heating, which thus deteriorates the cathode. Thus, when the conventional cathode oxide is used at a high current density to increase the electron emission density, the cathode may be deteriorated due to Joule heat, which abruptly shortens the cathode's lifespan.

Meanwhile, as shown in the reaction equations (2) and (3), during free barium production, in addition to free barium, byproducts such as MgO, Ba₂SiO₄, etc. are produced. These kinds of byproducts accumulate to form an interlayer at the interface between the electron-emitting material layer and the metal base, which acts as a diffusion barrier of reducing agent such as Mg, Si, etc. As a result, the production of free barium is suppressed, resulting in shortening of the cathode's life span. Moreover, since the interlayer has a high resistance, it disturbs the flow of the electron emissive current, limiting the current density of the cathode.

Along with popular trends toward high definition and larger screens for televisions or monitors using cathode-ray tubes, there has been an increasing need for cathodes with high current densities and longer life span. However, earlier oxide cathodes are not capable of satisfying this need due to the aforementioned disadvantages with respect to performance and life span.

An impregnated cathode is known for its high current density and long life span, but the manufacturing process thereof is complex and its operating temperature is approximately 1000 degrees Celsius, which is higher than that of oxide cathodes. Thus, an impregnated cathode needs to be made of expensive material with a much higher melting point, and its practical use is impeded.

From a practical point of view, it is preferable to improve the conventional oxide cathode so that it has a prolonged life span, and much research has been done in this area.

In detail, for example, Korean patent laid-open No. 91-17481 by Saito et al. for Cathode for Electron Tube (claiming the benefit of Japanese Patent Application No. 2-56855 for Cathode for Electron Tube) discloses a cathode for an electron tube, in which at least one metal layer such as tungsten or molybdenum is coated over a metal base and a rare earth metal oxide such as Sc₂O₃ is contained in an electron-emitting material layer, and claims that high current density and long life span can be realized since rare earth metal oxide such as scandium (Sc) serves to decompose the intermediate product and tungsten itself acts as a reducing agent to generate free barium.

However, tungsten (W), which acts as a reducing agent, generates not only free barium but also a byproduct expressed in the following reaction equation (4), causing abrupt deterioration of the cathode properties, in particular, the lifespan.

2BaO+⅓W→⅓Ba₃WO₆+Ba↑ (4)

Also, Japanese Patent Laid-Open No. Hei 8-50849 by Narita et al. for Cathode Member and Electronic Tube Using It (corresponding to EP 0685868 A1 for Cathode Member and Electron Tube Having the Cathode Member Mounted Thereon) discloses a cathode for an electron tube, which is a so-called hot isotatic press (HIP) cathode, in which metallic nickel powder and carbonate salt are mixed and molded at high temperature and high pressure, to serve as an electron emissive layer. The resultant electron emissive layer itself becomes conductive due to metallic nickel, and generation of Joule heat is considerably reduced under a high current density load. However, the HIP (hot isotatic press) cathode has an operating temperature of approximately 850 degrees Celsius, which is 50 degrees higher than that of the conventional oxide cathode, and the manufacturing process of the hot isotatic press cathode is complex, thereby greatly increasing the manufacturing cost.

Also, Japanese Patent Laid-Open No. Hei 6-28968 by Gärtner et al. for Cathode Containing Solid (corresponding to EP 05606436 B1 for Cathode with Solid Element) discloses a cathode for an electron tube with an improved life span, which is obtained by forming a conductive path based on a percolation principle by adding 20 to 80% by volume of spherical metal grains to an electron-emitting material layer used in the conventional oxide cathode. However, in order to exert a percolation effect by adding the spherical metal grains, at least 30% by weight of the metal grains must be contained in the electron-emitting material layer, which means that the content of the electron-emitting material layer is greatly reduced, resulting in a decrease in the initial emission current of the cathode. Another exemplar of the background art is U.S. Pat. No. 5,592,043 issued to Gärtner et al. for Cathode Including a Solid Body.

In an article titled “Progress on the Percolation Cathode”, IDW'99 Proceedings of the Sixth International Display Workshops CRT6-4 (Late-News Paper) by S. N. B. Hodgson, an oxide cathode having a percolation path made by adding 2.5 to 5% by volume of needle-shaped nickel grains to an electron-emitting material layer, is disclosed. However, the disclosed oxide cathode, in which an electron-emitting material layer is formed by a conventional spraying process, has a disadvantage in that its surface roughness is severe.

By a spray process in which coating is performed using a jet force caused by none other than air pressure, a uniform, dense coating film cannot be produced. The structure of an electron-emitting material layer coated by the spray process is shown in FIGS. 2 and 3. FIG. 2 is a scanning electron microscope photograph of an electron-emitting material layer coated by a spray process, taken with 400 times magnification, in which the sizes of pores between of grains are non-uniform and the surface thereof is very rough and coarse. FIG. 3 is a scanning electron microscope photograph of an electron-emitting material layer, taken with 3000 times magnification, from which it can be reconfirmed that the sizes of grains and the sizes of pores between each of the grains are non-uniform.

The rough surface of a cathode makes the electron emissive beams unevenly distributed throughout the screen to cause non-uniformity of image luminance and induces the “Moire” phenomenon in which fringe patterns are produced due to interference between the electron beams and dots on the screen. Also, if the cathode structure is not dense, pores may collapse or shrink due to a sintering effect after a long period of operation.

Thus, the distance between the cathode and a first grid increases, which eventually makes a difference in the electric potential between the cathode and first grid, which is set for controlling emission of electron beams, and which results in deterioration of luminance and lifetime characteristics due to a decrease in the amount of electron beam emitted.

As described above, when a cathode having an electron-emitting material layer which is not uniform in grain size, pore size and planarity, is inserted into an electron gun, the quality and reliability of a device may be lowered. The cathodes disclosed in the foregoing paragraphs cannot overcome these disadvantages.

### SUMMARY OF THE INVENTION

It is therefore an object of the present invention to provide an oxide cathode, which can suppress deterioration of the cathode due to self-heating by reducing the generation of Joule heat caused by intrinsic resistance of the oxide cathode.

It is another object of the present invention to provide an oxide cathode which can minimize a voltage distribution due to a difference in the distance between the cathode and a first grid, and also has improved life span and luminance when operated at a high current density, by solving the shrinkage problem of the cathode due to a long period of operating time.

It is yet another object to have a cathode with an electron-emitting layer with increased density and planarity.

It is still yet another object to have a cathode with grain and pore size of the electron-emitting layer being uniformly controlled.

It is another object to have a cathode that eliminates the “Moire” phenomenon in which fringe patterns are produced due to interference between the electron beams and dots on the screen.

To accomplish these and other objects, a cathode for an electron tube includes a metal base and an electron-emitting material layer coated on the metal base, where the electron-emitting material layer contains a needle-shaped conductive material. The surface roughness of the electron-emitting material layer corresponding to a distance between the highest point and the lowest point is controlled to be less than 10 μm (micrometers or microns).

In an embodiment of the present invention, the needle-shaped conductive material preferably has a specific resistance that is not higher than 10⁻¹ Ωcm (ohm centimeter).

Also, the needle-shaped conductive material preferably includes at least one of carbon, indium tin oxide, nickel, magnesium, rhenium, molybdenum and platinum.

More preferably, the needle-shaped conductive material is a carbonaceous material. The carbonaceous material may be selected from the group of a carbon nanotube, carbon fiber and laid graphite fiber.

The content of the needle-shaped conductive material contained in the electron-emitting material layer is preferably in the range of 0.01 to 30% by weight based on the total weight of electron-emitting material, and the thickness of the electron-emitting material layer is preferably in the range of 30 to 80 μm (micrometers or microns).

The electron-emitting material layer is preferably coated on the metal base by one of a printing method, an electrodeposition method and a painting method. More preferably, the electron-emitting material layer is coated on the metal base by a screen-printing method.

According to another aspect of the present invention, the cathode may further include a metal layer such as nickel having a grain size which is smaller than that of the metal base, between the metal base and the electron-emitting material layer.

The metal layer may further include 1 to 10% by weight of tungsten and 0.01 to 1% by weight of aluminum based on the total weight of nickel, and the thickness of the metal layer is preferably in the range of 1 to 30 μm (microns).

The metal layer may further include at least one metal selected from the group of tantalum (Ta), chromium (Cr), magnesium (Mg), silicon (Si) and zirconium (Zr).

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram of a general cathode for an electron tube;

FIG. 2 is a scanning electron microscope (SEM) photograph of an electron-emitting material layer of a conventional cathode, taken with 400 times magnification;

FIG. 3 is a scanning electron microscope (SEM) photograph of an electron-emitting material layer of the conventional cathode shown in FIG. 2, taken with 3000 times magnification;

FIG. 4 is a schematic diagram showing the structure of a cross section of an oxide cathode layer according to an embodiment of the present invention;

FIG. 5 is a schematic diagram showing the structure of a cross section of an oxide cathode layer according to an embodiment of the present invention;

FIG. 6 is a scanning electron microscope (SEM) of the oxide cathode layer shown in FIG. 4, taken with 400 times magnification;

FIG. 7 is a photograph of a scanning electron microscope (SEM) of the cathode shown in FIG. 4, taken with 3000 times magnification;

FIG. 8 is a graph showing a change in lifetime characteristics relative to the operating time of cathodes prepared in the Examples of the present invention and the Comparative Examples;

FIG. 9 shows a mean time to failure mode (MTTF) estimated from the evaluation results for the lifetime characteristics of cathodes prepared in the Examples of the present invention and the Comparative Examples;

FIG. 10 illustrates a variation in the cut-off voltage of cathodes prepared in the Examples of the present invention and the Comparative Examples;

FIG. 11 illustrates initial emission characteristics of cathodes prepared in the Examples of the present invention and the Comparative Examples; and

FIG. 12 illustrates the surface roughness of the electron-emitting material layer.

### DETAILED DESCRIPTION OF THE PREFERRED EMBODIMENTS

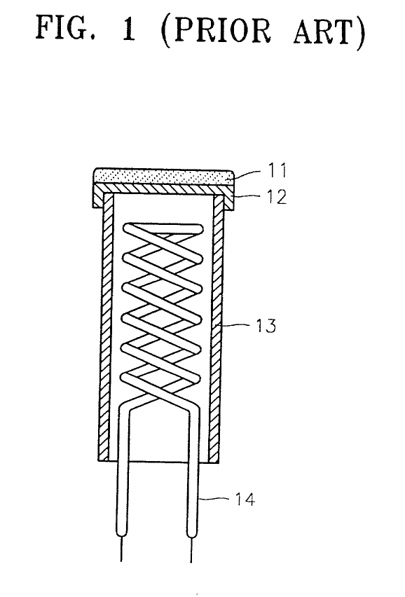

Turning now to the drawings, referring to FIG. 1, a cathode includes a disk-like metal base 12, a cylindrical sleeve 13 which is fitted to the bottom surface of the metal base 12 for support and provided with a heater 14 located inside the same for heating the cathode, and an electron-emitting material layer 11 coated on the upper surface of the metal base 12. The oxide cathode for an electron tube has the advantage of a relatively low operating temperature (700 to 800 degrees Celsius) due to the low work function, so that it is widely employed in general cathode-ray tubes.

Earlier oxide cathodes for electron tubes are generally configured such that the electron-emitting material layer 11 made of a barium-based alkali-earth metal carbonate, preferably a ternary carbonate containing barium, strontium and calcium in the form of (Ba—Sr—Ca)CO₃ or a binary carbonate containing barium, strontium and calcium in the form of (Ba—Sr)CO₃, is coated over the metal base 12 made of a nickel-based compound containing traces of a reducing agent such as silicon (Si), magnesium (Mg) or tungsten (W). The carbonate is converted into oxide by an evacuation or activation process and functions as an electron-emitting material.

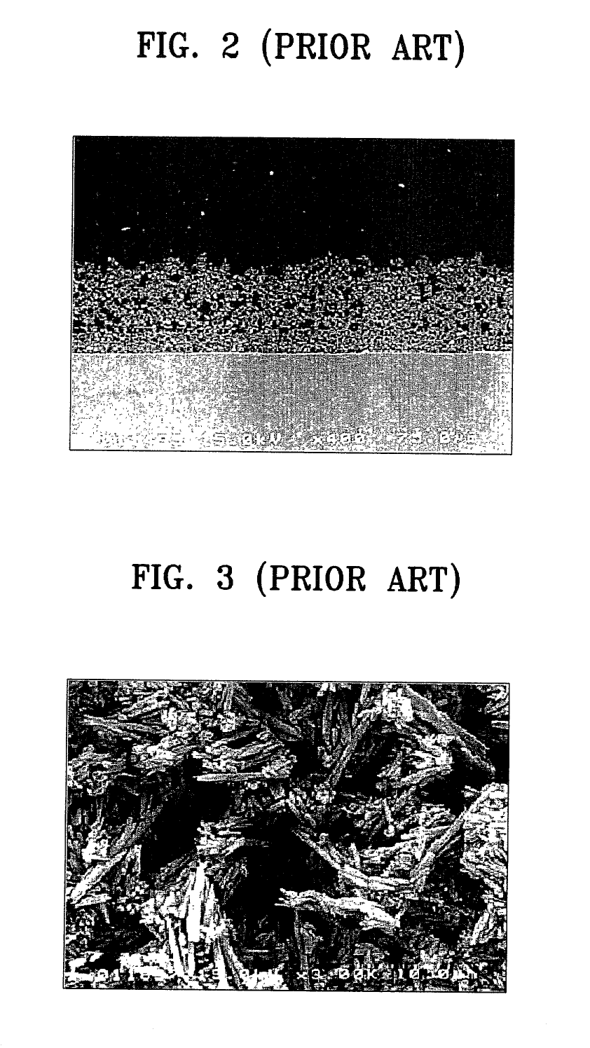

The structure of an electron-emitting material layer coated by the spray process is shown in FIGS. 2 and 3. FIG. 2 is a scanning electron microscope photograph of an electron-emitting material layer coated by a spray process, taken with 400 times magnification, in which the sizes of pores between of grains are non-uniform and the surface thereof is very rough and coarse. FIG. 3 is a scanning electron microscope photograph of an electron-emitting material layer, taken with 3000 times magnification, from which it can be reconfirmed that the sizes of grains and the sizes of pores between each of the grains are non-uniform.

A cathode for an electron tube according to the present invention will now be described in more detail with reference to the accompanying drawings.

In order to eliminate factors that induce deterioration of the life span of conventional cathodes under a high current density load, the cathode of the present invention has been developed. The present cathode contains a needle-shaped conductive material in an electron-emitting material layer, which more effectively forms a conductive path than spherical conductive grains. Thus, deterioration of the cathode due to self-heating can be suppressed, by reducing the generation of Joule heat caused by intrinsic resistance of the oxide cathode. Also, the surface roughness of the electron-emitting material is controlled to be in a predetermined range such that a voltage difference due to a difference in the distance between the cathode and a first grid is minimized. Also, shrinkage of the cathode due to a long operating time can be overcome, thereby improving the luminance and life span of the cathode when operated at a high current density.

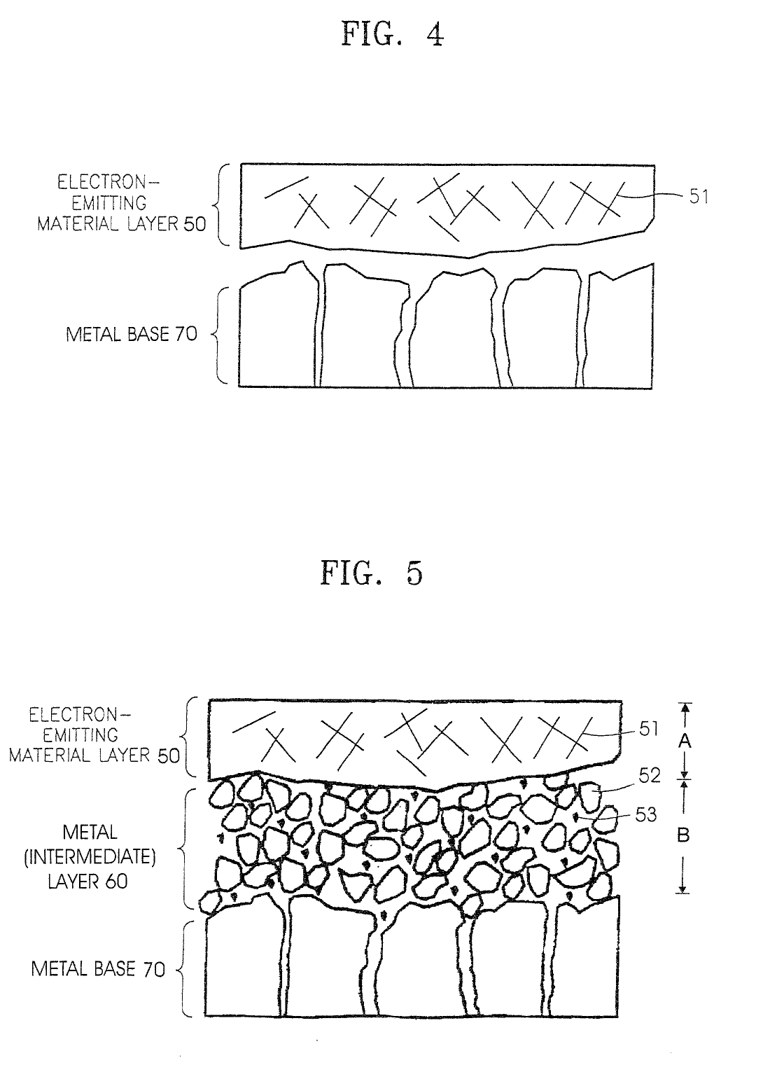

FIGS. 4 and 5 schematically show oxide cathode layers according to the present invention. In detail, FIG. 4 shows the structure of an oxide cathode having an electron-emitting material 50 containing a needle-shaped conductive material 51, directly coated on a metal base 70, and FIG. 5 shows the structure of a cathode having a metal (intermediate) layer 60 containing nickel metal 52 as a main component, formed between a metal base 70 and an electron-emitting material layer 50 containing a needle-shaped conductive material 51. The nickel metal 52 can be greater than 95% by weight of the metal layer 60. The metal layer 60 may further include a refractory metal for reinforcing the mechanical strength of the cathode, or a reducing agent 53.

In contrast with the electron-emitting material layer of the conventional oxide cathode, which is made of a barium-based carbonate, for example, a ternary carbonate (Ba—Sr—Ca)CO₃ or a binary carbonate (Ba—Sr)CO₃, the oxide cathode according to the present invention contains a needle-shaped conductive material in an electron-emitting material layer, as shown in FIGS. 4 and 5. The needle-shaped conductive material is electrically conductive with a specific resistance not higher than 10⁻¹ cm (centimeters), and is more advantageous to form a conductive path within the electron-emitting material layer than the spherical conductive material. Thus, deterioration due to generation of Joule heat can be sufficiently suppressed by adding a much smaller amount of the needle-shaped conductive material and also the content of the electron-emitting material is relatively increased, the initial emission characteristic is improved.

Further, as seen in FIG. 12, surface roughness of the electron-emitting material layer 50, which is measured as the distance “d” between the highest point 50a and the lowest point 50b on the surface of the electron-emitting material layer 50, is controlled to be under 10 μm (microns), a variation in the voltage due to a difference in the distance between the cathode and the first grid, is minimized, and shrinkage of the cathode due to a long operating time of the cathode can be reduced. Thus, luminance and life span under a high current density can be noticeably improved.

A process of preparing an oxide cathode according to the present invention will now be described.

Preparation of Carbonate Paste

Barium-based carbonate powder and needle-shaped conductive powder are homogeneously mixed with organic binder and organic solvent to prepare carbonate paste. The content of the needle-shaped conductive powder is preferably 0.01 to 30% by weight based on the total weight of the carbonate paste. If the content of the conductive powder is less than 0.01% by weight, the electrical conductivity of the electron-emitting material layer is not high enough to effectively reduce the Joule heat. If the content of the conductive powder is more than 30% by weight, the amount of the electron-emitting material is relatively reduced, which may adversely affect electron emission characteristics.

Usable materials for the needle-shaped conductive powder used in the oxide cathode according to the present invention include carbonaceous material such as carbon nanotube (CNT), carbon fiber or graphite fiber, needle-shaped indium tin oxide (ITO), needle-shaped metal such as nickel, magnesium, rhenium, molybdenum or platinum, and the like. In other words, any needle-shaped, conductive material that has a specific resistance of less than or equal to 10⁻¹ Ωcm (ohm centimeter), can be used in the present invention.

Carbonaceous material such as carbon nanotube is preferably used in an embodiment of the present invention. The carbonaceous material is advantageously used from the viewpoints of its stable structure at high temperature and a high ratio of length to diameter (i.e., its aspect ratio).

As the length of needle-shaped powder becomes longer, a conductive channel can be more effectively formed. In other words, as the length of the needle-shaped powder increases, the conductive channel is more advantageously formed. Thus, conductivity can be effectively imparted by adding a small amount of a conductive material.

Any carbonate salt generally used in manufacturing oxide cathodes can be used in the present invention, for example, (Ba—Sr—Ca)CO₃ or (Ba—Sr)CO₃. The amount of carbonate salt contained in the carbonate paste is preferably in the range of 40 to 60% by weight based on the total weight of the paste. If the amount of carbonate salt is less than 40% by weight, desired electron emission cannot be achieved. If the amount of the carbonate salt is greater than 60% by weight, the fluidity of the mixture is lowered, resulting in poor coating uniformity.

As the binder added to the carbonate paste, any binder that is typically used in the art can be used, and detailed examples of the binder include nitrocellulose, ethylcellulose and the like. The content of the binder is preferably in the range of 1 to 10% by weight based on the total weight of the carbonate paste used. If the content of the binder is less than 1% by weight, the adhesion may deteriorate after drying. If the content of the binder is greater than 10% by weight, side effects such as out-gassing or remnant impurity in the cathode layer may occur.

In order to maintain the mixture in the paste-like state, terpinol, butyl carbitol acetate or a combination of terpinol and butyl carbitol acetate is preferred as a non-volatile organic solvent. The content of the organic solvent is preferably in the range of 30 to 50% by weight based on the total weight of the carbonate paste to keep the paste suitable for printing. When the organic solvent is below 30%, the paste is too viscous to use for printing. When the organic solvent is above 50%, the paste is so thin, that the paste runs through the screen such that suitable printing to a desired area is not possible.

Formation of a Metal Layer on a Metal Base

Referring to FIG. 5, a metal layer 60 can be additionally inserted before the electron-emitting material layer 50 is formed, for the purpose of diffusing intermediate products and attaining a diffusion path of a reducing agent during the operation of a cathode. A metal layer formation process will now be briefly described.

Nickel powder and, optionally, a predetermined amount of tungsten or aluminum or both tungsten and aluminum as a reducing agent, are mixed, and then homogenously mixed with an organic binder and liquid-phase organic solvent, thereby preparing paste. The paste is coated on the surface of the metal base and then thermally treated in a vacuum or inert gas atmosphere, to obtain a metal layer without organic matter. Methods of coating the metal layer 60 on the metal base 70 include, but are not specifically restricted to, printing, spraying, electrodeposition or painting. However, in order to adjust the surface roughness of the cathode to be in a predetermined range, printing is most preferred.

Also, in order to increase adhesion between the metal layer and the electron-emitting material layer, the metal layer may take mesh or dot printing patterns. In screen printing, a printing mesh with such a printing pattern can be used.

The thickness (B) of a nickel metal layer is preferably 1 to 30 μm (microns). In the case of a pure nickel metal layer, the thickness of the pure nickel metal layer is preferably 2 to 3 μm (microns). If a reducing agent is added, good electron emission can be obtained from an even thicker nickel metal layer. When the thickness of a metal layer is above the range (above 30 microns of a nickel metal layer or above 3 microns of pure nickel metal layer), diffusion of a reducing agent is hindered, while when the thickness is less than the range (below 1 micron of a nickel metal layer or below 2 microns for pure nickel metal layer), the purpose of a metal layer cannot be achieved.

The reason for adding a reducing agent such as tungsten or aluminum to the metal layer is to compensate the lengthened diffusion path of the reducing agent of the base metal. Preferable is content of the reducing agent is 1 to 10% by weight for tungsten, and 0.01 to 1% by weight for aluminum, based on the total weight of nickel powder. When the contents of reducing agents are within these ranges, electron emission is superior and stable. The same effect can also be obtained by using a reducing metal such as tantalum, chromium, magnesium or silicon, instead of tungsten or aluminum. The reducing metal can also be any combination of metals such as tantalum, chromium, magnesium, or silicon.

Process of Manufacturing a Cathode

The thus-prepared carbonate paste containing the needle-shaped conductive material is coated on the surface of the metal base or on the nickel metal layer formed on the metal base, and then dried to complete a cathode. In the cathode for an electron tube according to the present invention, grains of the oxide layer are uniformly distributed without cohesion, and the sizes of pores are less than or equal to 10 μm (microns). The surface roughness of the cathode, which is measured as the distance between the highest point 50a and the lowest point 50b of the surface of the electron-emitting material layer, is preferably less than or equal to 10 μm (microns). In order to attain such a desired level of the surface roughness, any method fit for applying pressure on the coating layer, for example, printing, electrodeposition or painting, can be employed in coating the carbonate paste. Detailed examples of the printing method include screen printing, roll coating and the like.

However, a spraying technique which is generally used in fabricating an oxide cathode is not recommended in the present invention because the nozzle of a spray gun may be clogged by the needle-shaped conductive material contained in the carbonate paste, and the surface roughness is increased up to 20 μm (microns) due to cohesion among grains. Also, the unevenness of the coated surface unavoidably brings about disadvantages such as a decrease in electron emission, the Moire phenomenon, and a voltage variation between the cathode and first grid.

The electron-emitting material layer is preferably coated to a thickness (A) of 30 to 80 μm (microns), in order to obtain good electron emission characteristics without an abrupt change in the established manufacturing conditions. If the thickness (A) of the electron-emitting material layer is less than 30 μm (microns), the surface temperature of the cathode becomes too high and the lifespan gets shorter. If the thickness of the electron-emitting material layer is greater than 80 μm (microns), the surface temperature of the cathode becomes too low, which provokes decomposition of the carbonate during the evacuation process of a cathode-ray tube, which makes it difficult to attain good emission characteristics.

According to the present invention, an oxide cathode which is 2 to 3 times denser and about 2 times flatter than a conventional oxide cathode is provided. Thus, while greatly reducing the thickness of an electron-emitting material layer, cathode shrinkage can be prevented, thereby improving the luminance and lifetime characteristics of the cathode, and preventing defectiveness due to a variation in voltage applied between the cathode and first grid.

According to a preferred embodiment of the present invention, the electron-emitting material layer is coated on a metal base by a screen-printing method. In the screen-printing method, mesh made of cotton, nylon, TEFLON or stainless steel is tied to a frame, an ink permeable part and an ink impermeable part are formed, and ink is squeezed on a printed plane, thereby performing a printing operation. In a screen printing method, since the printing pressure is low due to a soft face of a substrate and an ink coated layer is thick, materials of printed matter can be freely selected and printing can be done even on a curved plane. The screen printing method can be applied to various substrates with wide industrial applications, including paper, plastic sheets, printed circuit boards and so on. In an embodiment of the present invention, a paste prepared by a powder material co-precipitated with carbonate salt rather than ink, needle-shaped conductive powder, an appropriate binder and an organic solvent is used in printing by means of a screen printer which operates based on the above-described principle.

The thus manufactured cathode is employed in assembling an electron gun and then an electron tube is completed through securing the electron gun into a screen funnel, evacuation and activation.

Now, effects based on various properties of the cathode for an electron tube according to the present invention will be described.

### EXAMPLE 1

60 g (grams) of a ternary carbonate containing Ba, Sr and Ca in the weight ratio of 57:30:4, 0.1 g of a carbon nanotube (CNT), 1 g of nitrocellulose and 39 g of terpinol were agitated and mixed with a roll mill to prepare a printing paste. The paste was coated on a metal base (cap) made of nickel to a thickness of 50 μm (microns) using a screen printer (commercially available from Newlong Seimitsu Kogyo Co., Japan, Model No. LS-34TV). Here, the printing pressure was 2 to 3 kgf/cm² (kilogram-force per centimeters squared) and the distance between the mesh of the screen printer and the cap was approximately 1.5 mm (millimeters). The resultant was dried at 150° C. (degrees Celsius) in an atmospheric state to complete a desired cathode.

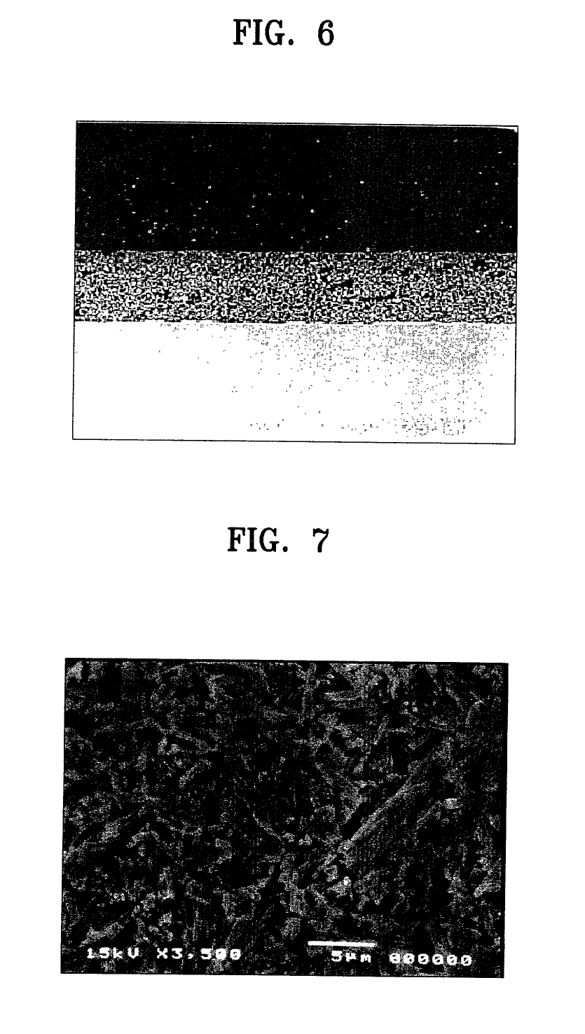

The cross-section and surface of the electron-emitting material layer of the thus-prepared cathode were examined by scanning electron microscope (SEM) observation. FIG. 6 is an scanning electron microscope photograph of the cross-section of the cathode, magnified by 400 times, and FIG. 7 is an scanning electron microscope photograph of the surface of the cathode, magnified by 3500 times. The scanning electron microscope photographs shown in FIGS. 6 and 7, show that the grain and pore sizes are relatively uniform and the resultant microstructures are densely formed, compared to those shown in FIGS. 2 and 3.

### EXAMPLE 2

Before printing a carbonate paste on a metal base, a metal layer forming paste prepared by homogenously mixing 10 g of nickel powder, 0.5 g of tungsten powder, 0.01 g of aluminum powder, 0.1 g of nitrocellulose and 5 g of terpinol, was screen-printed on the metal base to a thickness of 2 μm to form a metal layer. An electron-emitting material layer was formed on the metal layer in the same manner as in Example 1.

### EXAMPLE 3

A cathode for an electron tube was prepared in the same manner as in Example 2 except that the metal layer was printed using mesh patterns.

### EXAMPLE 4

A cathode for an electron tube was prepared in the same manner as in Example 1 except that carbon fiber was used instead of CNT (carbon nanotube).

### EXAMPLE 5

A cathode for an electron tube was prepared in the same manner as in Example 2 except that carbon fiber was used instead of carbon nanotube.

### EXAMPLE 6

A cathode for an electron tube was prepared in the same manner as in Example 2 except that needle-shaped ITO (indium tin oxide) powder was used instead of carbon nanotube.

### EXAMPLE 7

A cathode for an electron tube was prepared in the same manner as in Example 2 except that a nickel filament was used instead of carbon nanotube.

### EXAMPLE 8

A cathode for an electron tube was prepared in the same manner as in Example 2 except that platinum filament was used instead of carbon nanotube.

### COMPARATIVE EXAMPLE 1

A generally used spraying composition containing 40 to 50% by weight of carbonate powder, 0.3 to 0.4% by weight of nitrocellulose, 45 to 55% by weight of isoamylacetate and 4.5 to 5.5% by weight of diethyloxalate, was prepared. While a spray boot was maintained at a temperature of approximately 80° C. (degrees Celsius) and a pressure of 2 to 5 kgf/cm² (kilogram-force per centimeters squared), the prepared composition was coated by a spraying method to form an electron-emitting material layer and the resultant structure was dried at 150° C. in an atmospheric state. The SEM (scanning electron microscope) photographs of the cross-section and surface of the electron-emitting material layer are shown in FIGS. 2 and 3.

### COMPARATIVE EXAMPLE 2

A cathode for an electron tube was prepared in the same manner as in Comparative Example 1 except that 10% by weight of spherical nickel grains were added to the spraying composition.

Various characteristics demonstrated by the cathodes prepared in the Examples and the Comparative Examples were evaluated as follows.

(1) Lifetime Characteristic

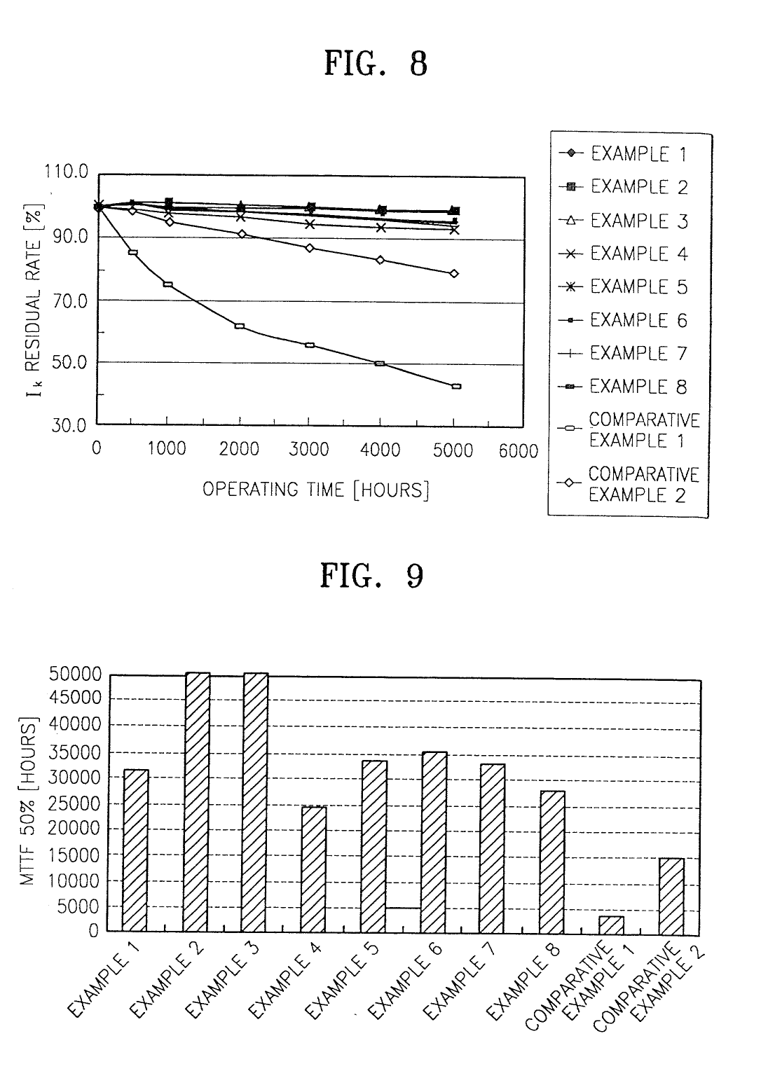

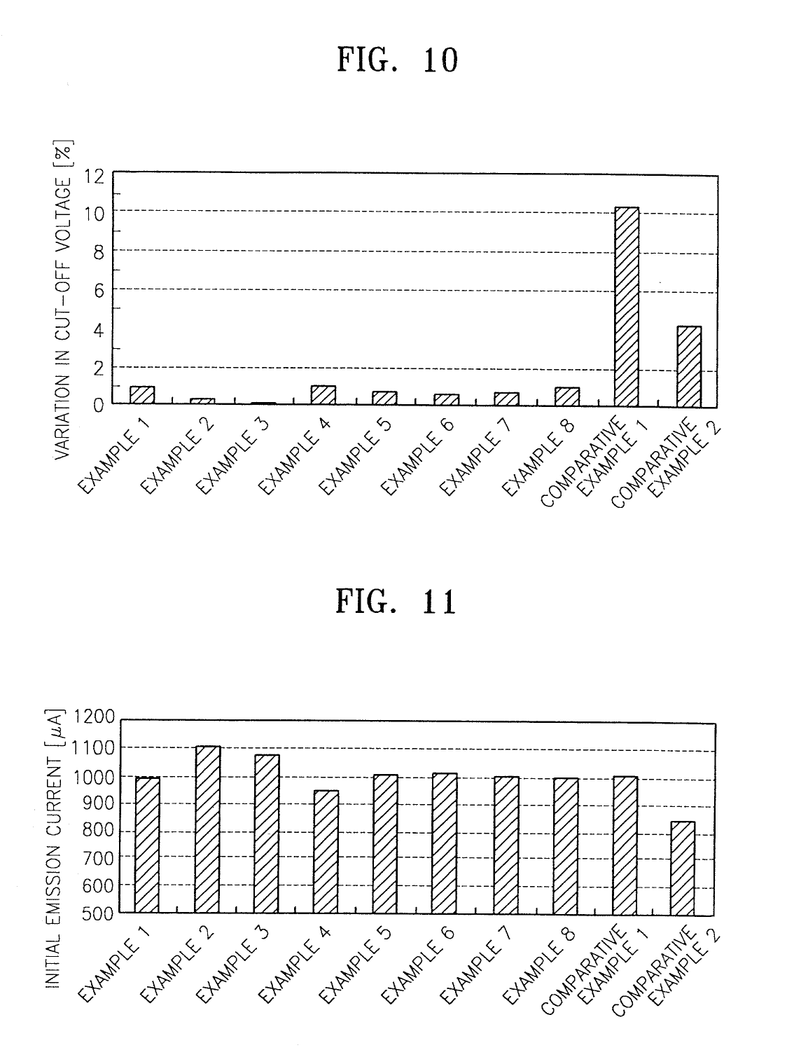

A lifetime characteristic of each prepared cathode was carried out by measuring a change in the cathode current (Ik) over operating time under cathode load conditions of the heater operating voltage of 6.3 V (volts), the operating temperature of 760° C. (degrees Celsius) and the initial current density of 5 A/cm² (amperes per centimeters squared), which was determined as the Ik (cathode current) residual rate for a predetermined period of time. Generally, the lifespan of a cathode is defined as values of a mean time to failure mode (MTTF), which corresponds to the lapse of time until the Ik (cathode current) residual rate reaches 50%. FIG. 8 shows evaluation results of the lifetime characteristics of the cathodes prepared in the Examples of the present invention and the Comparative Examples for a high current density of 5 A/cm² (amperes per centimeters squared), and FIG. 9 shows an MTTF (mean time to failure mode) estimated from the evaluation results for the lifetime characteristics of the cathodes prepared in the Examples of the present invention and the Comparative Examples. While the conventional cathode (Comparative Example 1) demonstrated 4,000 to 5,000 hours, the cathodes of the present invention demonstrated greater than or equal to 25,000 hours. That is, the lifetime characteristics remarkably improved compared to the conventional cathode. Also, the cathodes according to the present invention showed substantially no reduction in barium evaporation and cut off drift amount. FIG. 10 illustrates a variation in the cut-off voltage (cut-off drift) of cathodes operated for 5000 hours relative to the initial cut-off voltage, from which it was confirmed that the cathodes prepared in the Examples of the present invention showed noticeably reduced emission characteristics over operating time and excellent lifetime characteristics for a high current density of 5 A/cm² (Amperes per centimeters squared), compared to the cathodes prepared in Comparative Examples.

(2) Initial Emission Characteristic

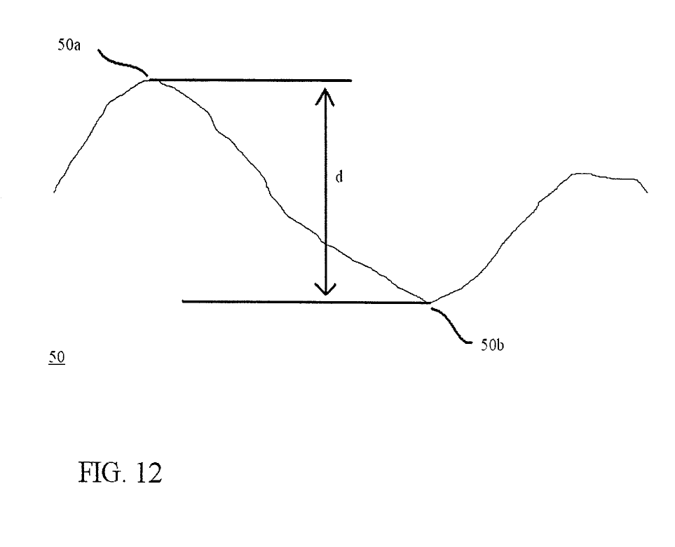

The initial emission characteristic is measured to evaluate the defectiveness or electron emission capability of a cathode of an electron gun immediately after an electron tube is fabricated, and is generally evaluated by measuring emission current from the cathode at a heater operating voltage of 6.3 V (volts) when predetermined voltages are applied to the cathode and electron gun grids. FIG. 11 illustrates initial emission characteristics (initial emission current in micro-amperes) of cathodes prepared in the Examples of the present invention and the Comparative Examples. Referring to FIG. 11, the cathodes for an electron tube according to the present invention, containing a smaller amount conductive material than the conventional cathode in Comparative Example 2, showed improved lifespan and initial emission characteristics compared to the conventional cathode in Comparative Example 2.

(3) Surface Roughness

The distance between the highest point and the lowest point of the cross-section of an oxide cathode layer was determined from an SEM (scanning electron microscope) photograph taken with 200 to 500 times magnification. The measurement results showed that the cathodes prepared in the Examples 1 and 2 had a surface roughness of less than or equal 5 μm (microns), whereas the cathodes prepared in Comparative Examples 1 and 2 had a surface roughness of approximately 20 μm (microns).

(4) Pore Size Distribution

Pore size distribution was determined as a ratio of a predetermined area to an area occupied by pores of a cathode photographed by an SEM (scanning electron microscope) taken with approximately 3000 times magnification. It was confirmed from the measurement results that the pore sizes of the cathodes of Examples 1 and 2 was less than or equal to 5 μm (microns), whereas the cathodes prepared in Comparative Examples 1 and 2 had the pore size of approximately 20 μm (microns).

(5) Grain Cohesion Size Distribution

The cathodes were photographed by an SEM (scanning electron microscope) having a magnifying power of approximately 3000 times to examine grain cohesion states. The results showed that carbonate grains each having a size of 5 to 7 μm (microns), were distributed without cohesion in the cathodes of Examples 1 and 2, whereas carbonate grains underwent cohesion to become 30 to 50 μm (microns) in size in the cathodes of Comparative Examples 1 and 2.

As described above, since the generation of Joule heat due to self-heating of an electron-emitting material layer containing a needle-shaped conductive material is reduced, a voltage variation due to non-uniformity in the distance between a cathode and a first grid is minimized even after use for a long time. Also, since the collapse or shrinkage of pores distributed in the cathode can be prevented by the high-density, high-planarity electron-emitting material layer, the cathodes according to the present invention demonstrated improved lifespan, cut-off voltage and picture quality characteristics.

As described above, in the cathode for an electron tube according to the present invention, a needle-shaped conductive material is contained in an electron-emitting material layer to effectively form a conductive path, thereby minimizing the generation of Joule heat due to self-heating of the electron-emitting material layer. Also, grain and pore sizes of the electron-emitting material layer are uniformly controlled and the density and porosity of the electron-emitting material layer are also controlled, thereby improving the density and surface planarity of the cathode compared to the conventional cathode manufactured by a spraying method. Thus, during the operation of the cathode, shrinkage of the cathode can be prevented and uniformity in the distance between a cathode and a first grid can be maintained, thereby improving a lifetime characteristic and exhibiting a stable emission characteristic. Therefore, the electron tube cathode according to the present invention can remarkably improve a lifetime characteristic even for a high current density, which is needed for a larger and higher-definition cathode-ray tube.

What is claimed is:

1. A cathode for an electron tube, comprising:
a metal base; and
an electron-emitting material layer coated on the metal base, said electron-emitting material layer comprising a needle-shaped conductive material.

2. The cathode of claim 1, further comprised of said needle-shaped conductive material being at least one material selected from the group consisting essentially of carbon, indium tin oxide, nickel, magnesium, rhenium, molybdenum and platinum.

3. The cathode of claim 1, further comprised of said needle-shaped conductive material being a carbonaceous material.

4. The cathode of claim 3, further comprised of said carbonaceous material being selected from the group consisting essentially of a carbon nanotube, carbon fiber and graphite fiber.

5. The cathode of claim 3, further comprised of said carbonaceous material being a carbon nanotube.

6. The cathode of claim 1, further comprised of said needle-shaped conductive material in the electron-emitting material layer being in the range of 0.01 to 30% by weight based on the total weight of said electron-emitting material.

7. The cathode of claim 1, further comprised of said needle-shaped conductive material being a carbonaceous material, said needle-shaped conductive material being in the range of 0.01 to 30% by weight based on the total weight of said electron-emitting material layer, and the thickness of said electron-emitting material layer being in the range of 30 to 80 μm.

8. The cathode of claim 1, further comprised of said electron-emitting material layer being coated on the metal base by one method selected from the group consisting essentially of printing, electrodeposition and painting.

9. The cathode of claim 1, further comprised of said electron-emitting material layer being coated on said metal base by a screen-printing.

10. A cathode for an electron tube, comprising:
a metal base; and
an electron-emitting material layer coated on the metal base, said electron-emitting material layer comprising a needle-shaped conductive material and a surface roughness corresponding to a distance between the highest point and the lowest point on the surface of the electron-emitting material layer being less than 10 microns.

11. The cathode of claim 10, wherein said cathode is an oxide cathode.

12. The cathode of claim 11, further comprised of said needle-shaped conductive material being at least one material selected from the group consisting essentially of carbon, indium tin oxide, nickel, magnesium, rhenium, molybdenum and platinum.

13. The cathode of claim 11, further comprised of said needle-shaped conductive material being a carbonaceous material.

14. The cathode of claim 13, further comprised of said carbonaceous material being selected from the group consisting essentially of a carbon nanotube, carbon fiber and graphite fiber.

15. The cathode of claim 13, further comprised of said carbonaceous material being a carbon nanotube.

16. The cathode of claim 11, further comprised of said needle-shaped conductive material in the electron-emitting material layer being in the range of 0.01 to 30% by weight based on the total weight of said electron-emitting material.

17. The cathode of claim 11, further comprised of said needle-shaped conductive material being a carbonaceous material, said needle-shaped conductive material being in the range of 0.01 to 30% by weight based on the total weight of said electron-emitting material layer, and the thickness of said electron-emitting material layer being in the range of 30 to 80 μm.

18. The cathode of claim 11, further comprised of said electron-emitting material layer being coated on the metal base by one method selected from the group consisting essentially of printing, electrodeposition and painting.

19. The cathode of claim 11, further comprised of said electron-emitting material layer being coated on said metal base by a screen-printing.

20. The cathode of claim 11, further comprising a metal layer including nickel grains having sizes smaller than the grains in said metal base, said metal layer formed between said metal base and said electron-emitting material layer.

21. The cathode of claim 20, further comprised of said metal layer further including at least one metal selected from the group consisting essentially of aluminum (Al), tungsten (W), tantalum (Ta), chromium (Cr), magnesium (Mg), silicon (Si) and zirconium (Zr).

22. The cathode of claim 20, further comprised of the thickness of said metal layer being in the range of 1 to 30 μm.

23. An oxide cathode for an electron tube, comprising:
a metal base; and
an electron-emitting material layer coated on the metal base, said electron-emitting material layer comprising a needle-shaped conductive material.

24. The cathode of claim 23, further comprised of said needle-shaped conductive material being at least one material selected from the group consisting essentially of carbon, indium tin oxide, nickel, magnesium, rhenium, molybdenum and platinum.

25. The cathode of claim 23, further comprised of said needle-shaped conductive material being a carbonaceous material.

26. The cathode of claim 25, further comprised of said carbonaceous material being selected from the group consisting essentially of a carbon nanotube, carbon fiber and graphite fiber.

27. The cathode of claim 25, further comprised of said carbonaceous material being a carbon nanotube.

28. The cathode of claim 23, further comprised of said needle-shaped conductive material in the electron-emitting material layer being in the range of 0. 01 to 3 0% by weight based on the total weight of said electron-emitting material.

29. The cathode of claim 23, further comprised of said needle-shaped conductive material being a carbonaceous material, said needle-shaped conductive material being in the range of 0.01 to 30% by weight based on the total weight of said electron-emitting material layer, and the thickness of said electron-emitting material layer being in the range of 30 to 80 μm.

30. The cathode of claim 23, further comprised of said electron-emitting material layer being coated on the-metal base by one method selected from the group consisting essentially of printing, electrodeposition and painting.

31. The cathode of claim 23, further comprised of said electron-emitting material layer being coated on said metal base by a screen-printing.

32. The cathode of claim 23, further comprising a metal layer including nickel grains having sizes smaller than the grains in said metal base, said metal layer formed between said metal base and said electron-emitting material layer.

33. The cathode of claim 32, further comprised of said metal layer further including at least one metal selected from the group consisting essentially of aluminum (Al), tungsten (W), tantalum (Ta), chromium (Cr), magnesium (Mg), silicon (Si) and zirconium (Zr).

34. The cathode of claim 32, further comprised of the thickness of said metal layer being in the range of 1 to 30 μm.
